(19) United States
(12) Patent Application Publication
(10) Pub. No.: US 2020/0368586 A1
(43) Pub. Date: Nov. 26, 2020

(54) RESIN COMPOSITION FOR GOLF BALLS

(71) Applicant: Bridgestone Sports Co., Ltd., Tokyo (JP)

(72) Inventors: Katsunobu Mochizuki, Chichibushi (JP); Masahiro Yamabe, Chichibushi (JP)

(73) Assignee: Bridgestone Sports Co., Ltd., Tokyo (JP)

(21) Appl. No.: 16/870,162

(22) Filed: May 8, 2020

(30) Foreign Application Priority Data
May 24, 2019 (JP) 2019-097542

(51) Int. Cl. A63B 37/00; C08L 75/04; C08L 53/02

(52) U.S. Cl. CPC A63B 37/0027; C08L 53/025; C08L 75/04; A63B 37/0094

(57) ABSTRACT

The invention provides a golf ball resin composition that includes (A) an aromatic vinyl elastomer and (B) a polyurethane or a polyurea, the amount of component (A) being 50 parts by weight or less per 100 parts by weight of component (B), and also provides a golf ball in which at least one cover layer is formed of this resin composition. The resin composition is particularly useful as a golf ball cover material because golf balls in which it is used do not fly too far and have a good controllability on approach shots, and moreover maintain a good scuff resistance and moldability without a loss of distance on shots with a driver.

### CROSS-REFERENCE TO RELATED APPLICATION

This non-provisional application claims priority under 35 U.S.C. § 119(a) on Patent Application No. 2019-097542 filed in Japan on May 24, 2019, the entire contents of which are hereby incorporated by reference.

### TECHNICAL FIELD

The present invention relates to a resin composition for golf balls and to a golf ball that uses the same. More particularly, the invention relates to a golf ball resin composition that is well-suited for use as the cover material in golf balls having a core encased by a cover of one or more layer, and to a golf ball made using this resin composition.

### BACKGROUND ART

The property most desired in a golf ball is an increased distance, but other desirable properties include the ability for the ball to stop well on approach shots and a good scuff resistance. Many golf balls have hitherto been developed that exhibit a good flight performance on shots with a driver and are suitably receptive to backspin on approach shots. Also, materials endowed with a high rebound and a good scuff resistance have been developed as golf ball cover materials.

Urethane resin materials are often used in place of ionomer resin materials as such cover materials, particularly in golf balls for professional golfers and skilled amateurs. However, professional golfers and skilled amateurs desire golf balls having even better controllability on approach shots. Specifically, they want excellent controllability and more delicate control around the green with short irons such as a sand wedge (SW). To this end, further improvements are being sought in cover materials made using a urethane resin as the base resin.

A number of polymer blend-type cover materials obtained by using a urethane resin as the base resin and mixing other resins therein have been described in the art. For example, to improve the scuff resistance of a cover material, JP-A H11-9721 discloses the use of a blend composed of a thermoplastic polyurethane and a styrene-based block copolymer as the base resin of the cover. However, covers made of this blend are inadequate in terms of their resilience and scuff resistance.

The properties of thermoplastic urethane elastomers have recently been upgraded, one such improved property being the scuff resistance. Hence, when another resin material is blended into such a thermoplastic urethane elastomer, it is desired that a decrease in the scuff resistance inherent to the thermoplastic urethane elastomer be avoided through judicious adjustments in the type and content of the blended resin.

In addition, it is also desired that, when blending a urethane resin material with another resin material for the purpose of lowering the hardness, changes in the resilience and worsening of the moldability be avoided to the extent possible.

### SUMMARY OF THE INVENTION

It is therefore an object of the present invention to provide a resin composition for golf balls which confers the ball with an excellent controllability on approach shots without lowering the distance traveled by the ball on shots with a driver, and which moreover can maintain a good scuff resistance and moldability.

As a result of extensive investigations, we have discovered that, in order to further improve the polyurethane covers that have hitherto been used in golf balls, by formulating a golf ball resin composition with (A) an aromatic vinyl elastomer and (B) a polyurethane or a polyurea and setting the amount of component (A) to 50 parts by weight or less per 100 parts by weight of component (B), golf balls made using the resin composition become even more controllable on approach shots taken by professional golfers and amateur golfers in particular, thus making it possible to provide high-quality golf balls which maintain a good scuff resistance and moldability without sacrificing the distance traveled by the ball on driver shots.

Accordingly, in a first aspect, the invention provides a golf ball resin composition having (A) an aromatic vinyl elastomer and (B) a polyurethane or a polyurea, wherein the amount of component (A) is 50 parts by weight or less per 100 parts by weight of component (B).

In a preferred embodiment of the golf ball resin composition according to the first aspect of the invention, component (A) is a hydrogenated aromatic vinyl elastomer.

In another preferred embodiment of the resin composition of the invention, component (A) is an elastomer obtained by hydrogenating a polymer comprising a polymer block composed primarily of an aromatic vinyl compound and a random copolymer blocks consisting of an aromatic vinyl compound and a conjugated diene compound.

In yet another preferred embodiment, component (A) is a hydrogenated aromatic vinyl elastomer obtained by hydrogenating a polymer comprising, at both ends thereof, a polymer block consisting of styrene and, in between, a random copolymer block consisting of styrene and butadiene.

In still another preferred embodiment, component (A) has a rebound resilience, as measured according to JIS-K 6255, of 40% or less.

In a further preferred embodiment, component (A) has a glass transition temperature (Tg), as indicated by the tan δ peak temperature obtained by measuring the dynamic viscoelasticity with a dynamic mechanical analyzer (DMA), of from −20 to 50° C.

In a yet further preferred embodiment, component (A) has a styrene component content of at least 30 wt %.

In a still further preferred embodiment, the polyurethane serving as the main component of the resin composition is an ether-based thermoplastic polyurethane.

In yet another preferred embodiment, the resin composition has a rebound resilience, as measured according to JIS-K 6255, of 65% or less.

In a second aspect, the invention provides a golf ball having a core encased by a cover or one or more layer, wherein at least one layer of the cover is formed of the resin composition according to the first aspect of the invention.

### Advantageous Effects of the Invention

The golf ball resin composition of the invention is particularly useful as a golf ball cover material because golf balls in which it is used do not fly too far and have a good controllability on approach shots, and moreover maintain a good scuff resistance and moldability without exhibiting a drop in distance on shots with a driver.

### DESCRIPTION OF THE PREFERRED EMBODIMENTS

The objects, features and advantages of the invention will become more apparent from the following detailed description.

The golf ball resin composition of the invention includes (A) an aromatic vinyl elastomer, and (B) a polyurethane or a polyurea. Components (A) and (B) are described in detail below.

### (A) Aromatic Vinyl Elastomer

The aromatic vinyl elastomer is a polymer (elastomer) comprising a polymer block composed primarily of an aromatic vinyl compound, and a random copolymer block consisting of an aromatic vinyl compound and a conjugated diene compound. That is, the aromatic vinyl elastomer generally has, as exemplified by SEBS, blocks consisting of an aromatic vinyl compound component which are located at both ends of the polymer and serve as hard segments, and a block consisting of a conjugated diene compound component which is located between the ends and serves as a soft segment. Polymers wherein an aromatic vinyl-based component has been randomly introduced into the conjugated diene compound component making up the intermediate block have also been reported in recent research. The hardness of an aromatic vinyl elastomer generally decreases as the content of the aromatic vinyl forming the hard segments becomes smaller; at the same time, because the amount of the soft segment component increases, the resilience rises. On the other hand, in cases where an aromatic vinyl component is randomly introduced into the soft segments of the intermediate block, the resilience decreases with little if any rise in the hardness. A similar effect can be obtained by using a conjugated diene compound having a high Tg in place of the aromatic vinyl compound that is randomly introduced into the intermediate block. In the present invention, to fully exhibit the above working effect, it is particularly desirable to use the above polymer (elastomer) in a hydrogenated form.

Examples of the aromatic vinyl compound in the polymer include styrene, α-methyl styrene, p-methyl styrene, divinylbenzene, 1,1-diphenylethylene, N,N-dimethyl-p-aminoethylstyrene and N,N-diethyl-p-aminoethylstyrene. These may be used singly, or two or more may be used together. Of these aromatic vinyl compounds, styrene is preferred.

Examples of the conjugated compound in the polymer include butadiene, isoprene, 2,3-dimethyl-1,3-butadiene, 1,3-pentadiene, 2-methyl-1,3-pentadiene and 1,3-hexadiene. These may be used singly, or two or more may be used together. Of these compounds, butadiene and isoprene are preferred. Butadiene is more preferred.

Units originating from the above conjugated diene compounds, such as units originating from butadiene, become ethylene units or butylene units when subjected to hydrogenation. For example, when a styrene-butadiene-styrene block copolymer (SBS) is hydrogenated, it becomes a styrene-ethylene/butylene-styrene block copolymer (SEBS).

As mentioned above, it is preferable for the aromatic vinyl elastomer used as component (A) to be one that has been hydrogenated; i.e., a hydrogenated aromatic vinyl elastomer. The hydrogenated vinyl elastomer is preferably an elastomer obtained by hydrogenating a polymer comprising a polymer block composed primarily of an aromatic vinyl compound and a random copolymer block consisting of an aromatic vinyl compound and a conjugated diene compound; and more preferably an elastomer obtained by hydrogenating a polymer comprising a polymer block composed primarily of styrene and a random copolymer blocks consisting of styrene and butadiene. An elastomer obtained by hydrogenating a polymer having a polymer block composed primarily of styrene and a random copolymer block consisting of styrene and butadiene, particularly one having at both ends a polymer block composed primarily of styrene (in particular, one having at both ends a polymer block consisting entirely of styrene) and having in between a random copolymer block, is especially preferred. It appears that, by using a copolymer having this structure, a lower hardness and a lower resilience are both achieved. In addition, the rate of solidification after molding is rapid, and so tack is low. Also, the compatibility with the polyurethane resin serving as component (B) is excellent, enabling any decreases in the physical properties owing to the blend to be held to a minimum.

Illustrative examples of the hydrogenated aromatic vinyl elastomer include styrene-ethylene/butylene-styrene block copolymers (SEBS), styrene-isobutylene-styrene block copolymers (SIBS), styrene-isoprene-styrene block copolymers (SIS), styrene-isobutylene block copolymers (SIB), styrene-ethylene/propylene-styrene block copolymers (SEPS), styrene-ethylene/ethylene/propylene-styrene block copolymers (SEEPS), styrene-butadiene/butylene-styrene block copolymers (SBBS) and styrene-ethylene-propylene block copolymers (SEP).

In the aromatic vinyl elastomer, the proportion of the copolymer accounted for by units originating from the aromatic vinyl compound (i.e., the aromatic vinyl compound content, preferably the styrene content) is preferably at least 30 wt %, more preferably at least 40 wt %, even more preferably at least 50 wt %, and most preferably at least 60 wt %. By thus setting the aromatic vinyl compound content, preferably the styrene content, to a high level, the compatibility with the urethane resin serving as component (B) is good and, moreover, worsening of the desired hardness and moldability can be prevented. The content of units from the above aromatic vinyl compound (preferably the styrene content) can be determined by calculation from H¹-NMR measurements.

In the aromatic vinyl elastomer, the glass transition temperature (Tg), as indicated by the tan δ peak temperature obtained by dynamic viscoelasticity measurement with a dynamic mechanical analyzer (DMA), is preferably from −20 to 50° C., more preferably at least 0° C., and even more preferably at least 5° C. The thinking here is that, by having the tan δ peak temperature be close to the temperature at which the golf ball is generally used, the resilience of the overall resin composition is kept low in the temperature region at which the golf ball is generally used, enabling the desired effects of the invention to be increased.

A commercial product may be used as the aromatic vinyl elastomer serving as component (A). Examples of such commercial products include those available under the trademarks S.O.E., TUFTEC and TUFPREN from Asahi Kasei Corporation, and those available under the trade name DICSTYRENE from DIC Corporation.

Component (A) has a rebound resilience, as measured according to JIS-K 6255, which is preferably 40% or less, more preferably 30% or less, and even more preferably 25% or less. By thus keeping the rebound resilience very low, a small amount of addition will not have an adverse influence on the golf ball properties, enabling a decrease in the ball initial velocity on approach shots to be achieved. To minimize the influence on the decrease in rebound and the reduction in distance on shots with a driver, it is preferable for this rebound resilience to have a lower limit of at least 20%.

It is critical for the content of component (A) to be 50 parts by weight or less per 100 parts by weight of the subsequently described component (B). The lower limit in this content is preferably at least 0.1 part by weight, more preferably at least 0.2 part by weight, and even more preferably at least 0.5 part by weight. When the content of component (A) is too high, the scuff resistance and moldability may worsen. On the other hand, when the content of component (A) is too low, the low hardness as a cover resin material and the desired resilience may not be obtained, and the ball initial velocity lowering effect on approach shots may diminish.

### (B) Polyurethane or Polyurea

Next, component (B) is a substance that is capable of serving as the base resin of the resin composition of the invention. The polyurethane (B-1) or polyurea (B-2) serving as this component is described in detail below.

### (B-1) Polyurethane

The polyurethane has a structure which includes soft segments composed of a polymeric polyol (polymeric glycol) that is a long-chain polyol, and hard segments composed of a chain extender and a polyisocyanate. Here, the polymeric polyol serving as a starting material may be any that has hitherto been used in the art relating to polyurethane materials, and is not particularly limited. It is exemplified by polyester polyols, polyether polyols, polycarbonate polyols, polyester polycarbonate polyols, polyolefin polyols, conjugated diene polymer-based polyols, castor oil-based polyols, silicone-based polyols and vinyl polymer-based polyols. Specific examples of polyester polyols that may be used include adipate-type polyols such as polyethylene adipate glycol, polypropylene adipate glycol, polybutadiene adipate glycol and polyhexamethylene adipate glycol; and lactone-type polyols such as polycaprolactone polyol. Examples of polyether polyols include poly(ethylene glycol), poly(propylene glycol), poly(tetramethylene glycol) and poly(methyltetramethylene glycol). These polyols may be used singly, or two or more may be used in combination.

It is preferable to use a polyether polyol as the above polymeric polyol.

The long-chain polyol has a number-average molecular weight that is preferably in the range of 1,000 to 5,000. By using a long-chain polyol having a number-average molecular weight in this range, golf balls made with a polyurethane composition that have excellent properties, including a good rebound and a good productivity, can be reliably obtained. The number-average molecular weight of the long-chain polyol is more preferably in the range of 1,500 to 4,000, and even more preferably in the range of 1,700 to 3,500.

Here and below, “number-average molecular weight” refers to the number-average molecular weight calculated based on the hydroxyl value measured in accordance with JIS-K1557.

The chain extender is not particularly limited; any chain extender that has hitherto been employed in the art relating to polyurethanes may be suitably used. In this invention, low-molecular-weight compounds with a molecular weight of 2,000 or less which have on the molecule two or more active hydrogen atoms capable of reacting with isocyanate groups may be used. Of these, preferred use can be made of aliphatic diols having from 2 to 12 carbon atoms. Specific examples include 1,4-butylene glycol, 1,2-ethylene glycol, 1,3-butanediol, 1,6-hexanediol and 2,2-dimethyl-1,3-propanediol. Of these, the use of 1,4-butylene glycol is especially preferred.

Any polyisocyanate hitherto employed in the art relating to polyurethanes may be suitably used without particular limitation as the polyisocyanate. For example, use can be made of one or more selected from the group consisting of 4,4′-diphenylmethane diisocyanate, 2,4-toluene diisocyanate, 2,6-toluene diisocyanate, p-phenylene diisocyanate, xylylene diisocyanate, 1,5-naphthylene diisocyanate, tetramethylxylene diisocyanate, hydrogenated xylylene diisocyanate, dicyclohexylmethane diisocyanate, tetramethylene diisocyanate, hexamethylene diisocyanate, isophorone diisocyanate, norbornene diisocyanate, trimethylhexamethylene diisocyanate, 1,4-bis(isocyanatomethyl)cyclohexane and dimer acid diisocyanate. However, depending on the type of isocyanate, crosslinking reactions during injection molding may be difficult to control.

The ratio of active hydrogen atoms to isocyanate groups in the polyurethane-forming reaction may be suitably adjusted within a preferred range. Specifically, in preparing a polyurethane by reacting the above long-chain polyol, polyisocyanate and chain extender, it is preferable to use the respective components in proportions such that the amount of isocyanate groups included in the polyisocyanate per mole of active hydrogen atoms on the long-chain polyol and the chain extender is from 0.95 to 1.05 moles.

The method for preparing the polyurethane is not particularly limited. Preparation using the long-chain polyol, chain extender and polyisocyanate may be carried out by either a prepolymer process or a one-shot process via a known urethane-forming reaction. Of these, melt polymerization in the substantial absence of solvent is preferred. Production by continuous melt polymerization using a multiple screw extruder is especially preferred.

It is preferable to use a thermoplastic polyurethane material as the polyurethane, with an ether-based thermoplastic polyurethane material being especially preferred. The thermoplastic polyurethane material used may be a commercial product, illustrative examples of which include those available under the trade name PANDEX from DIC Covestro Polymer, Ltd., and those available under the trade name RESAMINE from Dainichiseika Color & Chemicals Mfg. Co., Ltd.

### (B-2) Polyurea

The polyurea is a resin composition composed primarily of urea linkages formed by reacting (i) an isocyanate with (ii) an amine-terminated compound. This resin composition is described in detail below.

### (i) Isocyanate

The isocyanate is not particularly limited. Any isocyanate used in the prior art relating to polyurethanes may be suitably used here. Use may be made of isocyanates similar to those mentioned above in connection with the polyurethane material.

### (ii) Amine-Terminated Compound

An amine-terminated compound is a compound having an amino group at the end of the molecular chain. In this invention, the long-chain polyamines and/or amine curing agents shown below may be used.

A long-chain polyamine is an amine compound which has on the molecule at least two amino groups capable of reacting with isocyanate groups, and which has a number-average molecular weight of from 1,000 to 5,000. In this invention, the number-average molecular weight is more preferably from 1,500 to 4,000, and even more preferably from 1,900 to 3,000. Examples of such long-chain polyamines include, but are not limited to, amine-terminated hydrocarbons, amine-terminated polyethers, amine-terminated polyesters, amine-terminated polycarbonates, amine-terminated polycaprolactones, and mixtures thereof. These long-chain polyamines may be used singly, or two or more may be used in combination.

An amine curing agent is an amine compound which has on the molecule at least two amino groups capable of reacting with isocyanate groups and which has a number-average molecular weight of less than 1,000. In this invention, the number-average molecular weight is more preferably less than 800, and even more preferably less than 600. Specific examples of such amine curing agents include, but are not limited to, ethylenediamine, hexamethylenediamine, 1-methyl-2,6-cyclohexyldiamine, tetrahydroxypropylene ethylenediamine, 2,2,4- and 2,4,4-trimethyl-1,6-hexanediamine, 4,4′-bis(sec-butylamino)dicyclohexylmethane, 1,4-bis(sec-butylamino)cyclohexane, 1,2-bis(sec-butylamino)cyclohexane, derivatives of 4,4′-bis(sec-butylamino)dicyclohexylmethane, 4,4′-dicyclohexylmethanediamine, 1,4-cyclohexane bis(methylamine), 1,3-cyclohexane bis(methylamine), diethylene glycol di(aminopropyl) ether, 2-methylpentamethylenediamine, diaminocyclohexane, diethylenetriamine, triethylenetetramine, tetraethylenepentamine, propylenediamine, 1,3-diaminopropane, dimethylaminopropylamine, diethylaminopropylamine, dipropylenetriamine, imidobis(propylamine), monoethanolamine, diethanolamine, triethanolamine, monoisopropanolamine, diisopropanolamine, isophoronediamine, 4,4′-methylenebis(2-chloroaniline), 3,5-dimethylthio-2,4-toluenediamine, 3,5-dimethylthio-2,6-toluenediamine, 3,5-diethylthio-2,4-toluenediamine, 3,5-diethylthio-2,6-toluenediamine, 4,4′-bis(sec-butylamino)diphenylmethane and derivatives thereof, 1,4-bis(sec-butylamino)benzene, 1,2-bis(sec-butylamino)benzene, N,N′-dialkylaminodiphenylmethane, N,N,N′,N′-tetrakis(2-hydroxypropyl)ethylenediamine, trimethylene glycol di-p-aminobenzoate, polytetramethylene oxide di-p-aminobenzoate, 4,4′-methylenebis(3-chloro-2,6-diethyleneaniline), 4,4′-methylenebis(2,6-diethylaniline), m-phenylenediamine, p-phenylenediamine and mixtures thereof. These amine curing agents may be used singly or two or more may be used in combination.

(iii) Polyol

Although not an essential ingredient, in addition to above components (i) and (ii), a polyol may also be included in the polyurea. The polyol is not particularly limited, but is preferably one that has hitherto been used in the art relating to polyurethanes. Specific examples include the long-chain polyols and/or polyol curing agents mentioned below.

The long-chain polyol may be any that has hitherto been used in the art relating to polyurethanes. Examples include, but are not limited to, polyester polyols, polyether polyols, polycarbonate polyols, polyester polycarbonate polyols, polyolefin-based polyols, conjugated diene polymer-based polyols, castor oil-based polyols, silicone-based polyols and vinyl polymer-based polyols. These long-chain polyols may be used singly or two or more may be used in combination.

The long-chain polyol has a number-average molecular weight of preferably from 1,000 to 5,000, and more preferably from 1,700 to 3,500. In this average molecular weight range, an even better resilience and productivity are obtained.

The polyol curing agent is preferably one that has hitherto been used in the art relating to polyurethanes, but is not subject to any particular limitation. In this invention, use may be made of a low-molecular-weight compound having on the molecule at least two active hydrogen atoms capable of reacting with isocyanate groups and having a molecular weight of less than 1,000. Of these, the use of aliphatic diols having from 2 to 12 carbon atoms is preferred. Specific examples include 1,4-butylene glycol, 1,2-ethylene glycol, 1,3-butanediol, 1,6-hexanediol and 2,2-dimethyl-1,3-propanediol. The use of 1,4-butylene glycol is especially preferred. The polyol curing agent has a number-average molecular weight of preferably less than 800, and more preferably less than 600.

A known method may be used to produce the polyurea. A prepolymer process, a one-shot process or some other known method may be suitably selected for this purpose.

Component (B) has a material hardness on the Shore D hardness scale which, from the standpoint of the spin properties and scuff resistance that can be obtained in the golf ball, is preferably 65 or less, more preferably 60 or less, and even more preferably 55 or less. From the standpoint of the moldability, the lower limit in the material hardness on the Shore D scale is preferably at least 25, and more preferably at least 30.

Component (B) serves as the base resin of the resin composition. From the standpoint of fully imparting the scuff resistance of the urethane resin, it accounts for at least 50 wt %, preferably at least 60 wt %, more preferably at least 70 wt %, even more preferably at least 80 wt %, and most preferably at least 90 wt %, of the resin composition.

In addition to the resin components described above, other resin materials may also be included in the golf ball resin composition of the invention. The purposes for doing so are, for example, to further improve the flowability of the resin composition and to increase such ball properties as the rebound and scuff resistance.

Specific examples of other resin materials that may be used include polyester elastomers, polyamide elastomers, ionomer resins, ethylene-ethylene/butylene-ethylene block copolymers and modified forms thereof, polyacetals, polyethylenes, nylon resins, methacrylic resins, polyvinyl chlorides, polycarbonates, polyphenylene ethers, polyarylates, polysulfones, polyethersulfones, polyetherimides and polyamideimides. These may be used singly or two or more may be used together.

In addition, an isocyanate compound having an activity may be included in the resin composition of the invention. This active isocyanate compound reacts with the polyurethane or polyurea serving as the base resin, enabling the scuff resistance of the overall resin composition to be further increased. Moreover, the isocyanate has a plasticizing effect which increases the flowability of the resin composition, enabling the moldability to be improved.

Any isocyanate compound employed in conventional polyurethanes may be used without particular limitation as the above isocyanate compound. For example, aromatic isocyanate compounds that may be used include 2,4-toluene diisocyanate, 2,6-toluene diisocyanate and mixtures of both, 4,4-diphenylmethane diisocyanate, m-phenylene diisocyanate and 4,4′-biphenyl diisocyanate. Use can also be made of the hydrogenated forms of these aromatic isocyanate compounds, such as dicyclohexylmethane diisocyanate. Other isocyanate compounds that may be used include aliphatic diisocyanates such as tetramethylene diisocyanate, hexamethylene diisocyanate (HDI) and octamethylene diisocyanate; and alicyclic diisocyanates such as xylene diisocyanate. Further examples of isocyanate compounds that may be used include blocked isocyanate compounds obtained by reacting the isocyanate groups on a compound having two or more isocyanate groups on the ends with a compound having active hydrogens, and uretdiones obtained by the dimerization of isocyanate.

The amount of the above isocyanate compounds included per 100 parts by weight of the polyurethane or polyurea resin serving as the base resin is preferably at least 0.1 part by weight, and more preferably at least 0.5 part by weight. The upper limit is preferably not more than 30 parts by weight, and more preferably not more than 20 parts by weight. When too little is included, a sufficient crosslinking reaction may not be obtained and an increase in the properties may not be observable. On the other hand, when too much is included, discoloration over time due to heat and ultraviolet light may increase, or problems such as a loss of thermoplasticity or a decline in resilience may arise.

In addition, optional additives may be suitably included in the golf ball resin composition of the invention according to the intended use thereof. For example, when the golf ball resin composition of the invention is to be used as a cover material, various additives, such as inorganic fillers, organic staple fibers, reinforcing agents, crosslinking agents, pigments, dispersants, antioxidants, ultraviolet absorbers and light stabilizers, may be added to the ingredients described above. When such additives are included, the amount thereof, per 100 parts by weight of the base resin, is preferably at least 0.1 part by weight, and more preferably at least 0.5 part by weight, but preferably not more than 10 parts by weight, and more preferably not more than 4 parts by weight.

When the rebound resilience of the resin composition of the invention is too high, the resin composition has a distance-increasing effect on shots with a driver, but the ball initial velocity on approach shots is likewise high, making the ball difficult to control. For this reason, it is preferable for the rebound resilience measured in accordance with JIS-K 6255 to be 65% or less. In order to minimize decreases in the rebound and the distance of the ball on shots with a driver, it is preferable for this rebound resilience to be at least 30%.

The resin composition of the invention has a material hardness on the Shore D hardness scale which, from the standpoint of the spin properties and scuff resistance of the golf ball, is preferably 60 or less, more preferably 55 or less, even more preferably 50 or less, and most preferably 45 or less. From the standpoint of moldability, the Shore D hardness is preferably at least 20, and more preferably at least 30.

The golf ball resin composition of the invention may be prepared by mixing together the ingredients using any of various types of mixers, such as a kneading-type single-screw or twin-screw extruder, a Banbury mixer, a kneader or a Labo Plastomill. Alternatively, the ingredients may be mixed together by dry blending when the resin composition is to be injection-molded. In addition, when an active isocyanate compound is used, it may be incorporated at the time of resin mixture using various types of mixers, or a resin masterbatch already containing the active isocyanate compound and other ingredients may be separately prepared and the various components mixed together by dry blending when the resin composition is to be injection-molded.

The golf ball resin composition of the invention may be used as a resin material for various parts of a golf ball. For example, it may be used as the material for a one-piece golf ball itself. Alternatively, it may be advantageously used as a cover material in two-piece solid golf balls having a core and a cover encasing the core, or in multi-piece solid golf balls having a core of one or more layer and a multilayer cover encasing the core.

The cover molding method may involve, for example, feeding the resin composition into an injection molding machine and molding the cover by injecting the molten resin composition over a core. In this case, the molding temperature differs according to the type of polyurethane or polyurea serving as component (B), but is typically in the range of 150 to 270° C.

### EXAMPLES

The following Examples and Comparative Examples are provided to illustrate the invention, but are not intended to limit the scope thereof.

### Examples 1 to 13, Comparative Examples 1 to 3

A core-forming rubber composition formulated as shown in Table 1 and common to all of the Examples was prepared and then molded and vulcanized to produce a 38.6 mm diameter core.

TABLE 1

| Rubber composition | parts by weight |
|---|---|
| cis-1,4-Polybutadiene | 100 |
| Zinc acrylate | 27 |
| Zinc oxide | 4.0 |
| Barium sulfate | 16.5 |
| Antioxidant | 0.2 |
| Organic peroxide (1) | 0.6 |
| Organic peroxide (2) | 1.2 |
| Zinc salt of penta- | 0.3 |
| chlorothiophenol | |
| Zinc stearate | 1.0 |

Details on the above core materials are given below.
cis-1,4-Polybutadiene: Available under the trade name “BR 01” from JSR Corporation
Zinc acrylate: From Nippon Shokubai Co., Ltd.
Zinc oxide: From Sakai Chemical Co., Ltd.
Barium sulfate: From Sakai Chemical Co., Ltd.
Antioxidant: Available under the trade name “Nocrac NS6” from Ouchi Shinko Chemical Industry Co., Ltd.
Organic peroxide (1): Dicumyl peroxide, available under the trade name “Percumyl D” from NOF Corporation
Organic peroxide (2): A mixture of 1,1-di(tert-butylperoxy)cyclohexane and silica, available under the trade name “Perhexa C-40” from NOF Corporation
Zinc stearate: Available from NOF Corporation

Next, an intermediate layer-forming resin material common to all of the Examples was formulated. This intermediate layer-forming resin material was a blend of 50 parts by weight of a sodium-neutralized ethylene-unsaturated carboxylic acid copolymer having an acid content of 18 wt % and 50 parts by weight of a zinc-neutralized ethylene-unsaturated carboxylic acid copolymer having an acid content of 15 wt %, for a combined amount of 100 parts by weight. This resin material was injection-molded over the 38.6 mm diameter core obtained as described above, thereby producing an intermediate layer-encased sphere having an intermediate layer with a thickness of 1.25 mm.

Next, the cover materials shown in Tables 2 and 3 below were injection-molded over the intermediate layer-encased spheres in the amounts indicated in these tables, thereby producing 42.7 mm diameter three-piece golf balls having a cover layer (outermost layer) with a thickness of 0.8 mm. Dimples common to all the Examples and Comparative Examples were formed on the surface of the cover.

### Preparation of Cover-Forming Resin Composition

The ingredients were mixed in the amounts shown in Tables 2 and 3 by dry blending, and the resin compositions thus prepared were injection-molded at a molding temperature of 210 to 250° C.

TABLE 2

| | Comparative | | | | | | | | |
|---|---|---|---|---|---|---|---|---|---|
| Cover | Example | Example | | | | | | | |
| formulation (pbw) | 1 | 1 | 2 | 3 | 4 | 5 | 6 | 7 | 8 |
| TPU | 100 | 100 | 100 | 100 | 100 | 100 | 100 | 100 | 100 |
| S.O.E. S1611 | | 0.5 | 1 | 3 | 5 | 10 | 15 | 25 | 50 |
| MH-6800-1 | | | | | | | | | |
| Hytrel 4001 | | | | | | | | | |
| Rebound resilience (%) | 61 | 61 | 61 | 60 | 57 | 54 | 51 | 44 | 30 |

TABLE 3

| Cover | Example | | | | | Comparative Example | |
|---|---|---|---|---|---|---|---|
| formulation (pbw) | 9 | 10 | 11 | 12 | 13 | 2 | 3 |
| TPU | 100 | 100 | 100 | 100 | 100 | 100 | 100 |
| S.O.E. S1611 | | | | | | | |
| MH-6800-1 | 1 | 3 | 10 | 25 | 50 | | |
| Hytrel 4001 | | | | | | 3 | 10 |
| Rebound resilience (%) | 61 | 60 | 59 | 53 | 46 | 61 | 62 |

Details on the ingredients included in the compositions in Tables 2 and 3 are give below.
TPU: An aromatic ether-type thermoplastic polyurethane available from DIC Covestro Polymer, Ltd. under the trade name “Pandex” (Shore D hardness, 40; rebound resilience, 61%)
S.O.E. S1611: A hydrogenated aromatic vinyl elastomer available from Asahi Kasei Corporation (styrene content, 60 wt %; Shore D hardness, 23; rebound resilience, 20%)
MH-6800-1: A vinyl elastomer available from DIC Corporation as the impact-resistance polystyrene resin DICSTYRENE (HIPS) (Shore D hardness, 74; rebound resilience, 37%)
Hytrel 4001: A polyester elastomer available from DuPont-Toray Co., Ltd. (Shore D hardness, 37; rebound resilience, 77%)

The golf balls obtained in each of the Examples and Comparative Examples were measured to determine the initial velocity and distance on shots taken with a driver and the initial velocity on approach shots. Evaluations of the moldability and scuff resistance and sensory evaluations of the golf balls on approach shots were carried out as described below. These results are presented in Tables 4 and 5.

### Ball Properties on Driver Shots (DR Initial Velocity and DR Distance)

A driver was mounted on a swing robot, and the initial velocity of the ball immediately after being struck at a head speed (HS) of 45 m/s was measured with an apparatus for measuring the initial conditions. The distance traveled by the ball was also measured.

### Ball Properties on Approach Shots (AP Initial Velocity)

A sand wedge (SW) was mounted on a golf swing robot and the initial velocity of the ball immediately after being struck at a head speed (HS) of 20 m/s was measured with an apparatus for measuring the initial conditions. Using the initial velocity on an approach shot in Comparative Example 1 as the reference, the initial velocity differences between the balls in the respective Examples and the ball in Comparative Example 1 were determined.

### Controllability on Approach Shots

Sensory evaluations of the golf ball on approach shots were carried out based on the following criteria.

Excellent (Exc): Excellent controllability

Good: Good controllability

Fair: Acceptable controllability

NG: Somewhat poor controllability

### Evaluation of Scuff Resistance

The golf balls were held isothermally at 23° C. and five balls of each type were hit at a head speed of 33 m/s using as the club a pitching wedge mounted on a swing robot machine. The damage to the ball from the impact was visually rated according to the following criteria.

Excellent (Exc): Slight scuffing or substantially no apparent scuffing.

Good: Slight fraying of surface or slight dimple damage.

NG: Dimples completely obliterated in places.

### Evaluation of Moldability (Mold Releasability)

Releasability of the ball from the mold following injection molding of the cover was rated according to the following criteria.
Good: External defects such as runner stubs and ejector pin marks do not arise during demolding.
Fair: External defects such as runner stubs and ejector pin marks arise during demolding, but molding proceeds without difficulty.
NG: External defects such as runner stubs and ejector pin marks arise during demolding, and molding is impossible.

TABLE 4

| | | Comp. Ex. | Example | | | | | | | |
|---|---|---|---|---|---|---|---|---|---|---|
| | | 1 | 1 | 2 | 3 | 4 | 5 | 6 | 7 | 8 |
| Ball | DR initial | 66.81 | 66.82 | 66.82 | 66.82 | 66.81 | 66.81 | 66.81 | 66.80 | 66.79 |
| properties | velocity (m/s) | | | | | | | | | |
| | DR distance (m) | 235 | 235 | 236 | 235 | 236 | 236 | 235 | 235 | 235 |
| | AP initial | 19.30 | 19.27 | 19.24 | 19.20 | 19.15 | 19.10 | 19.05 | 18.91 | 18.72 |
| | velocity (m/s) | | | | | | | | | |
| | AP initial velocity: | — | −0.03 | −0.06 | −0.10 | −0.15 | −0.20 | −0.25 | −0.39 | −0.58 |
| | difference with | | | | | | | | | |
| | Comparative Example 1 | | | | | | | | | |
| Evaluations | Controllability | NG | good | good | Exc | Exc | Exc | Exc | Exc | Exc |
| | on approach shots | | | | | | | | | |
| | Scuff resistance | good | good | good | good | good | good | good | good | fair |
| | Moldability | good | good | good | good | good | good | good | good | good |
| | (mold releasability) | | | | | | | | | |

It is apparent from the results in Table 4 that, in Examples 1 to 8 according to the present invention, the rebound (initial velocity) on approach shots can be lowered without lowering the rebound (initial velocity) and distance on driver shots, and the controllability on approach shots is good. It is also apparent that the scuff resistance and moldability can be maintained at a good level.

TABLE 5

| | | Example | | | | | Comparative Example | |
|---|---|---|---|---|---|---|---|---|
| | | 9 | 10 | 11 | 12 | 13 | 2 | 3 |
| Ball | DR initial velocity (m/s) | 66.81 | 66.82 | 66.81 | 66.82 | 66.81 | 66.82 | 66.82 |
| properties | DR distance (m) | 236 | 236 | 235 | 235 | 235 | 236 | 235 |
| | AP initial velocity (m/s) | 19.29 | 19.24 | 19.21 | 19.13 | 19.03 | 19.30 | 19.30 |
| | AP initial velocity: | −0.01 | −0.06 | −0.09 | −0.17 | −0.27 | 0.00 | 0.00 |
| | difference with | | | | | | | |
| | Comparative Example 1 | | | | | | | |
| Evaluations | Controllability | fair | good | Exc | Exc | Exc | NG | NG |
| | on approach shots | | | | | | | |
| | Scuff resistance | good | good | good | fair | fair | good | good |
| | Moldability | good | good | good | good | fair | good | good |
| | (mold releasability) | | | | | | | |

It is apparent from the results in Table 5 that, in Examples 9 to 13 according to the present invention, the rebound (initial velocity) on approach shots can be lowered without lowering the rebound (initial velocity) on driver shots, the controllability on approach shots can be improved without lowering the distance on driver shots, and the scuff resistance and moldability does not suffer. By contrast, in Comparative Examples 2 and 3 in which the resin compositions were obtained by blending a small amount of polyester elastomer into a thermoplastic polyurethane resin (TPU), the distance on driver shots does not fall but there is no decrease in the initial velocity on approach shots and so the controllability is poor.

Japanese Patent Application No. 2019-097542 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A golf ball resin composition comprising:
(A) an aromatic vinyl elastomer, and
(B) a polyurethane or a polyurea,
wherein the amount of component (A) is 50 parts by weight or less per 100 parts by weight of component (B).

2. The resin composition of claim 1, wherein component (A) is a hydrogenated aromatic vinyl elastomer.

3. The resin composition of claim 1, wherein component (A) is an elastomer obtained by hydrogenating a polymer comprising a polymer block composed primarily of an aromatic vinyl compound and a random copolymer block consisting of an aromatic vinyl compound and a conjugated diene compound.

4. The resin composition of claim 1, wherein component (A) is a hydrogenated aromatic vinyl elastomer obtained by hydrogenating a polymer comprising, at both ends thereof, a polymer block consisting of styrene and, in between, a random copolymer block consisting of styrene and butadiene.

5. The resin composition of claim 1, wherein component (A) has a rebound resilience, as measured according to JIS-K 6255, of 40% or less.

6. The resin composition of claim 1, wherein component (A) has a glass transition temperature (Tg), as indicated by the tan 6 peak temperature obtained by dynamic viscoelasticity measurement with a dynamic mechanical analyzer (DMA), of from −20 to 50° C.

7. The resin composition of claim 1, wherein component (A) has a styrene component content of at least 30 wt %.

8. The resin composition of claim 1, wherein the polyurethane serving as the main component of the composition is an ether-based thermoplastic polyurethane.

9. The resin composition of claim 1, wherein the resin composition has a rebound resilience, as measured according to JIS-K 6255, of 65% or less.

10. A golf ball comprising a core encased by a cover of one or more layer, wherein at least one layer of the cover is formed of the resin composition of claim 1.
